(19) United States
(12) Patent Application Publication
(10) Pub. No.: US 2003/0035602 A1
(43) Pub. Date: Feb. 20, 2003

(54) Injection molded fabric lined self-lubricating bearing

(76) Inventors: Benjamin A. Shobert, Carmel, IN (US); Ray E. Wolff, South Bend, IN (US)

Correspondence Address: Todd T. Taylor, TAYLOR & AUST, P.C., P.O. Box 560, 142 S. Main St., Avilla, IN, 46710, US

(21) Appl. No.: 09/931,751

(22) Filed: Aug. 16, 2001

(51) Int. Cl. F16C 33/18

(52) U.S. Cl. 384/298

(57) ABSTRACT

A low-friction bearing is a hollow cylinder including an inner bearing surface. The bearing includes an inner anti-friction layer, a second load bearing composite laminate and an outer backing layer. The inner layer characteristically both has a low coefficient of friction and is wear-resistant. The inner bearing surface is defined by the inner layer, the inner layer being a woven material composed of commingled low-friction fibers and wear-resistant fibers, the woven material being impregnated with a resin. The second layer is composed of a continuous filament composite which results in significantly improved load capacities and impact fatigue. An outer backing layer is made substantially of a thermoplastic material, the outer backing layer being molded upon the inner layer.

### BACKGROUND OF THE INVENTION

1. Field of the Invention

The present invention relates to bearings, and, more particularly, to bearings including an anti-friction inner layer and at least one backing layer.

2. Description of the Related Art.

Traditional non-metallic bearing materials utilize one of several composition structures such as a continuous filament backing (typically filament wound or braided in construction), an integrated woven and laminated bearing material (typically cotton fiber with phenolic resin as the reinforcing matrix) and a solid injection molded thermoplastic bearing material that may or may not have some anti-friction filler or fibrous or milled powdered dispersion therein. Some well known anti-friction materials are polytetrafluoroethylene (PTFE), silicone, graphite, molybdenum di-sulfide (MoS₂) and PolyEsterEsterKetone (PEEK).

Current filled thermoplastic systems (i.e., filled with liquid lubricant and/or fibrous/particulate lubricants) employ fillers that are mixed evenly into the entire bearing cross-section. Such filled thermoplastics can not resist cold flow under high static and dynamic loading conditions; are subject to high friction build as such surfaces are not 100% self-lubricating; and are rather expensive. Additionally, in such filled systems, the anti-friction material is spread throughout the body and is not concentrated at the work surface, thereby adding to the overall expense of the material and effectively reducing the potential wear resistant of a given surface.

What is needed in the art is a bearing which exhibits very unique wear resistance, has high static and dynamic capacities, long-term impact resistance and is relatively inexpensive to produce.

### SUMMARY OF THE INVENTION

The present invention provides a bearing or bushing which incorporates anti-friction materials into the inner liner thereof and which has one or more backing layers attached thereto.

The invention comprises, in one form thereof, a low-friction bearing, the low-friction bearing being a hollow cylinder including an inner bearing surface. The bearing includes an inner anti-friction layer, a second load bearing composite laminate and an outer backing layer. The inner layer characteristically both has a low coefficient of friction and is wear-resistant. The inner bearing surface is defined by the inner layer, the inner layer being a woven material composed of commingled low-friction fibers and wear-resistant fibers, the woven material being impregnated with a resin. The second layer is a continuous filament composition which provides the primary load capacities and impact fatigue. An outer backing layer is made substantially of a thermoplastic material, the outer backing layer being molded upon the second layer.

An advantage of the present invention is that the multi-layer laminate structure thereof allows such a bearing to be wear-resistant, load-bearing yet relatively inexpensive.

Another advantage is that the woven wear surface material can be made of a self-lubricating material capable of generating a non-hydrodynamic layer of lubrication through a film transfer process (the process by which a self-lubricating bearing wear surface fills in the surface voids of the mating wear surface).

Yet another advantage is that the woven wear surface of the bearing provides a very high load bearing wear surface.

Yet an even further advantage is that such a bearing is resistant to cold flow under high static and dynamic loading conditions.

An even yet further advantage is that such a bearing may be used as a bushing, an inner bearing race or an outer bearing race, preferably as a bushing or an outer bearing race.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a partial cut away view of a fabric-lined bearing of the present invention;

FIG. 2 is side view of a resin bath into which a bearing insert of the present invention is placed;

FIG. 3 illustrates the step of cutting used for use in the method of the present invention; and

FIG. 4 illustrates the step of injection molding used in the method of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

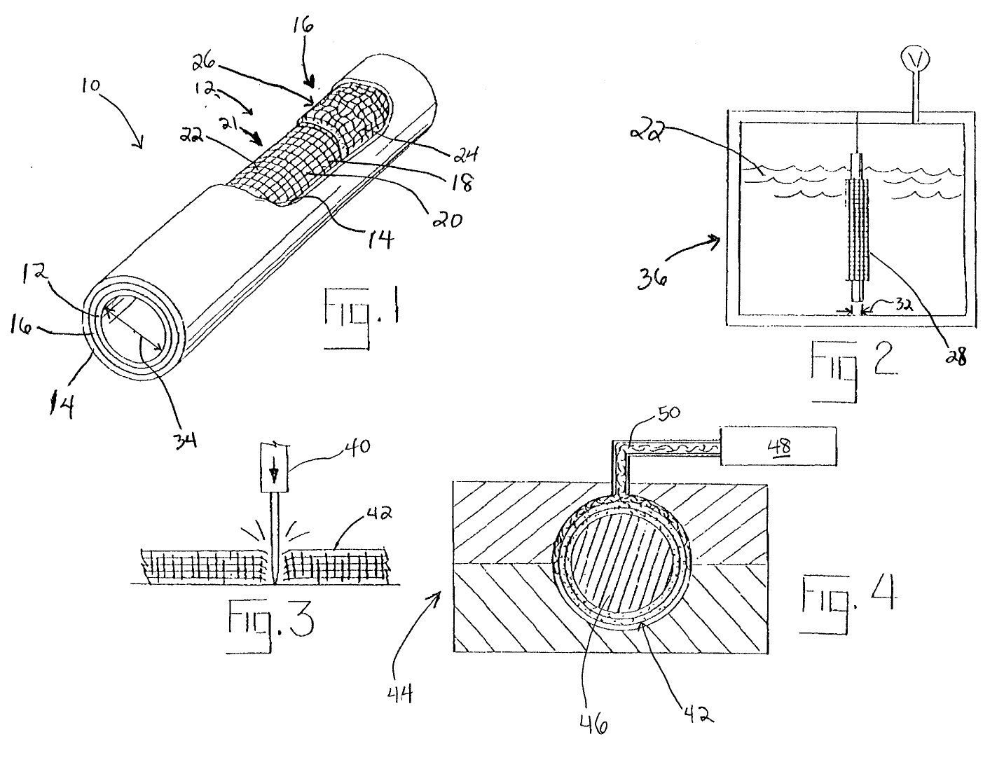

Referring now to the drawings, and more particularly to FIG. 1, there is shown a low-friction bearing 10 which generally includes an inner layer or laminate 12 which characteristically has a low coefficient of friction and is wear resistant, and outer backing layer or laminate 14 and, preferably, intermediate load bearing layer or laminate 16.

Inner layer 12 includes low-friction fibers 18 and wear-resistant fibers 20. Low-friction fibers 18 and wear-resistant fibers 20 are commingled and helically wrapped or circumferentially braided. Fibers 18, 20 are continuous throughout the radial and axial direction of inner layer 12. That is to say, fibers 18, 20 are not short fiber materials that have a high degree of random structure within bearing 10. Fibers 18, 20 are, in fact, specifically oriented within inner layer 12. Inner layer 12 preferably has a thickness of about 0.010 inches to about 0.020 inches. Low-friction fibers and wear-resistant fibers 20 together form bearing liner material 21.

Low-friction fibers 18 are preferably composed of a self-lubricating material, such as PTFE. Such a self-lubricating material is able to create boundary lubrication during the cycling of bearing 10 by a film transfer process. Wear-resistant fibers 20 are necessary in conjunction with low-friction fibers 18 to ensure that proper bonding can occur between low-friction fibers 18 and intermediate load bearing layer 16. In a preferred embodiment, low-friction fibers 18 are made of PTFE, and wear-resistant fibers 20 are polyester fibers.

Inner layer 12 further includes resin 22 which is preferably vacuum impregnated between fibers 18, 20. Resin 22 is preferably thermosetting in nature. Suitable resin systems may include, but are not limited to, epoxy, polyester, vinylester, cyclics and phenolic.

Outer backing layer 14 is made of an engineered thermoplastic which may be either filled or unfilled. Outer backing layer 14 does not have the load carrying capacity of inner layer 12 or intermediate load bearing layer 16 yet does offer moderate load capacity. Outer backing layer 14 does significantly lower the cost of a bearing compared to if it had been manufactured entirely of constituent materials from inner layer 12 and intermediate load bearing layer 16. Outer backing layer 14 may incorporate some 100% axial reinforcement (not shown) in its construction to optimize deflection characteristics.

Intermediate layer 16 functions as the primary load bearing member of low-friction bearing 10. Intermediate load bearing layer 16 is composed of a load-bearing material 24. Load-bearing material 24 is a continuous filament material that is helically wrapped or circumferentially braided. Fiberglass and organic filaments such as cotton are usable as the continuous filament material of load-bearing material 24. Intermediate load bearing 16 is produced with an outer surface 26 which is rough in order to insure that it can properly mechanically lock to outer backing layer 14.

Low-friction bearing 10 may be used as a bushing, an inner bearing race, or an outer bearing race. It is preferable to use low-friction bearing 10 as an outer bearing race or as a bushing in order to best utilize the low-friction properties of inner layer 12. Specifically, low-friction bearing 10 may be used as a journal bearing.

Low-friction bearing 10 is made by a multiple step process (FIGS. 2-4). Bearing insert precursor 28 is formed by first wrapping bearing liner material 21 around a mandrel 30 and then wrapping load-bearing material 24 around the layer of bearing liner material 21. Mandrel 30 has an outer diameter 32, which in turn determines the final inner diameter 34 of inner layer 12. Bearing insert precursor 28, thus mounted on mandrel 30, is then placed in a resin bath 36 of resin 22. A vacuum source 38 is used to pull a vacuum on resin bath 36 which induces full resin impregnation between the various filaments within bearing insert precursor 28. Bearing insert precursor 28, a near net shape composite, is then taken and cured in an oven (not shown). Once cured, bearing insert precursor 28 is pulled off mandrel 30 and is cut to length using cutting mechanism 40, thereby forming at least one bearing insert 42. Bearing insert 42 is of the length specified by the finished bearing length.

Finished bearing 10 is completed by performing an injection step using injection molding tool 44. Bearing insert 42 is placed over core pin 46 within injection molding tool 44, and injection molding tool 44 is then closed. Thermoplastic source 48 is then activated, thereby injecting thermoplastic material 50 around bearing insert 42. Upon injecting thermoplastic material 50 around the entire circumference of bearing insert 42, thermoplastic 50 is then cured and low-friction bearing 10 is thereby completed.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A low-friction bearing, said bearing being a hollow cylinder including an inner bearing surface, said bearing comprising:
an inner layer which characteristically both has a low coefficient of friction and is wear-resistant, said inner bearing surface being defined by said inner layer, said inner layer being a woven material comprised of commingled low-friction fibers and wear-resistant fibers, said woven material being impregnated with a resin; and
an outer backing layer comprised substantially of a thermoplastic material, said outer backing layer being molded upon said inner layer.

2. The bearing of claim 1, wherein said low-friction fibers are at least one of helically wrapped and circumferentially braided.

3. The bearing of claim 1, wherein each low-friction fiber is comprised of one of polytetrafluoroethylene, silicone, graphite, molybdenum disilicide and polyesteresterketone.

4. The bearing of claim 1, wherein said commingled low-friction fibers and wear-resistant fibers continuously extend radially and axially within said inner layer, said low-friction fibers and wear-resistant fibers thereby being specifically oriented with respect to said inner bearing surface.

5. The bearing of claim 1, wherein said resin is one of epoxy, polyester, vinylester, cyclics and phenolic.

6. The bearing of claim 1, wherein said resin is vacuum impregnated into said woven material.

7. The bearing of claim 1, wherein said thermoplastic material is an engineered thermoplastic, said engineered thermoplastic being one of filled and unfilled.

8. The bearing of claim 1, further comprising an intermediate load bearing layer located between and bonded to said inner layer and said outer backing layer.

9. The bearing of claim 8, wherein said intermediate layer is configured for acting as the primary load bearing member of said bearing.

10. The bearing of claim 8, wherein said intermediate layer is comprised of a load-bearing, continuous filament material, said filament material being one of helically wrapped and circumferentially braided.

11. The bearing of claim 10, wherein said filament material includes an amount of 100% axial reinforcement in the construction thereof to optimize deflection characteristics thereof.

12. The bearing of claim 8, wherein said intermediate layer has an outer face, said outer face thereof being rough to promote mechanical locking with said outer backing layer.

13. The bearing of claim 8, wherein said intermediate layer is impregnated with said resin.

14. A low-friction bearing insert, comprising:
a woven material comprised of commingled low-friction fibers and wear-resistant fibers; and
a resin impregnated within said woven material.

15. The bearing insert of claim 14, wherein said low-friction fibers are at least one of helically wrapped and circumferentially braided.

16. The bearing insert of claim 14, wherein each low-friction fiber is comprised of one of polytetrafluoroethylene, silicone, graphite and molybdenum disilicide.

17. The bearing insert of claim 14, wherein said commingled low-friction fibers and wear-resistant fibers continuously extend radially and axially within said woven material, said low-friction fibers and wear-resistant fibers thereby being specifically oriented within said woven material.

18. The bearing insert of claim 14, wherein said resin is one of epoxy, polyester, vinylester, cyclics and phenolic.

19. The bearing insert of claim 14, wherein said resin is vacuum impregnated into said woven material.

20. A method of manufacturing a bearing, said bearing being a hollow cylinder, said hollow cylinder having an inner bearing surface, said method comprising the steps of:
providing a woven material comprised of commingled low-friction fibers and wear-resistant fibers;
wrapping said woven material around a mandrel, said woven material forming an inner layer of said bearing, said mandrel having an outer diameter, said outer diameter thereof determining an inner diameter of said inner layer and thus of said bearing;
impregnating said woven material with a resin;
curing said impregnated inner layer;
cutting said cured impregnated inner layer to a final length of said bearing to thereby form a bearing insert; and
molding an outer backing layer around said bearing insert, said outer backing layer being comprised substantially of a thermoplastic material.

21. The method of claim 20, said molding step including the substeps of:
providing an injection molding device, said injection molding device having a core pin therein for aligning a part therewithin;
placing said bearing insert on said core pin within said injection molding device;
closing said injection molding device with said bearing insert mounted therein; and
injection molding said thermoplastic material around said bearing insert.

22. The method of claim 20, further comprising the step of:
between said wrapping step and said impregnating step, forming a load-bearing layer upon said inner layer by at least one of braiding and helically wrapping load-bearing filaments therearound, said load-bearing layer thereby being subject to the same subsequent processing steps as said inner layer, said load-bearing layer being located between said inner layer and said outer backing layer upon performing of said molding step.

23. The method of claim 22, wherein upon performing said cutting step, said inner layer and said load-bearing layer together comprise said bearing insert.

24. The method of claim 20, wherein said step of impregnating includes the substeps of:
placing said wrapped inner layer and said mandrel into said resin bath; and
then subjecting said resin bath to a vacuum, thereby inducing full resin impregnation into said woven material of said inner layer to form an impregnated inner layer.

25. The method of claim 20, wherein said thermoplastic material is injected molded.

26. The method of claim 20, wherein said thermoplastic material is an engineered thermoplastic, said engineered thermoplastic being one of filled and unfilled.
